(19) United States
(12) Patent Application Publication
(10) Pub. No.: US 2007/0068960 A1
(43) Pub. Date: Mar. 29, 2007

(54) Pill dispenser

(75) Inventors: Scott Valentine, Stockport (GB); Jonathan Hart, Stockport (GB); Mark Chadwick, Stockport (GB)

Correspondence Address: NIKOLAI & MERSEREAU, P.A., 900 SECOND AVENUE SOUTH, SUITE 820, MINNEAPOLIS, MN, 55402, US

(73) Assignee: SurgiChem Limited, Stockport (GB)

(21) Appl. No.: 11/438,543

(22) Filed: May 22, 2006

Related U.S. Application Data
(63) Continuation of application No. PCT/GB04/04827, filed on Nov. 15, 2004.
(63) Continuation of application No. PCT/GB04/04928, filed on Nov. 18, 2004.

(30) Foreign Application Priority Data
Nov. 13, 2003 (GB) 0326439.7

(51) Int. Cl. G07F 11/66

(52) U.S. Cl. 221/25

(57) ABSTRACT

A pill dispenser (10) having a body (12) including a plurality of recesses (14) formed in a surface (16) of the body (12). Each recess (14) has an open mouth (18) bounded by a surrounding portion (20) of said body surface (16). The open mouth (18) of each recess (14) is closed by an imperforate cover (22) secured to the surrounding portion (20) which bounds the recess (14). A lid (24) is hingedly connected to the body (12) for movement between a first position whereat the lid (24) overlies the mouth (18) of all of the recesses (14) to prevent access thereto and a second position whereat the lid (24) is spaced from the mouths (18) of the recesses (14) to permit access thereto.

The invention relates to a pill dispenser for dispensing pills, tablets or capsules, or combinations thereof.

It is known in hospitals and other establishments such as, for example, nursing homes, where the dosage of medicines for individual patients is made up from a central dispensary, to use pill dispensers to store the medicines for individual patients and provide a practical aid to indicate when the medicines should be taken.

One such known pill dispenser is disclosed in European patent number 0 541 643, and includes a box having a hinged lid. A removable tray is located in the box; the tray having a plurality of compartments in which pills, tablets and/or capsules are stored. The lid defines a plurality of windows aligned with the compartments in the tray, and a perforated film is sealed over the compartments to allow the contents of the tray to be dispensed selectively through the windows. The perforations in the film assist removal of the film in a selective manner.

This type of pill dispenser is rendered re-usable by the use of a removable tray, which may be replaced when empty. A pharmacist at a remote location typically fills replacement trays with medicines before sending the trays in a “secure” container, to prevent tampering, to the hospital or nursing home.

The pill dispenser may be rendered tamper-evident with a frangible locking member to lock the lid in a closed position.

The re-usable nature of such known pill dispensers means that they are generally expensive and, therefore, not suitable for use in pharmacies where medicines are dispensed to patients for use at home since, in such circumstances, a programme of medicines is often dispensed in a one-off manner.

A general aim of the invention therefore is to provide a pill dispenser which is suitable for dispensing a programme of medicines in a one-off manner.

According to an aspect of the invention, there is provided a pill dispenser having a body including a plurality of recesses formed in a surface of the body, each recess having an open mouth bounded by a surrounding portion of said body surface, the open mouth of each recess being closed by an imperforate cover secured to the surrounding portion which bounds the recess, a lid hingedly connected to the body for movement between a first position whereat the lid overlies the mouth of all of the recesses to prevent access thereto and a second position whereat the lid is spaced from the mouths of the recesses to permit access thereto.

Advantageously, the pill dispenser may be used to provide a practical aid to indicate the timetable associated with a specific programme of medicines in the form of pills, tablets or capsules, or combinations thereof, whilst at the same time acting as a disposable packaging for the medicines.

Other advantageous features of the invention are defined in dependent claims 2-14.

An embodiment of the invention will now be described, by way of a non-limiting example, with reference to the accompanying drawings in which:

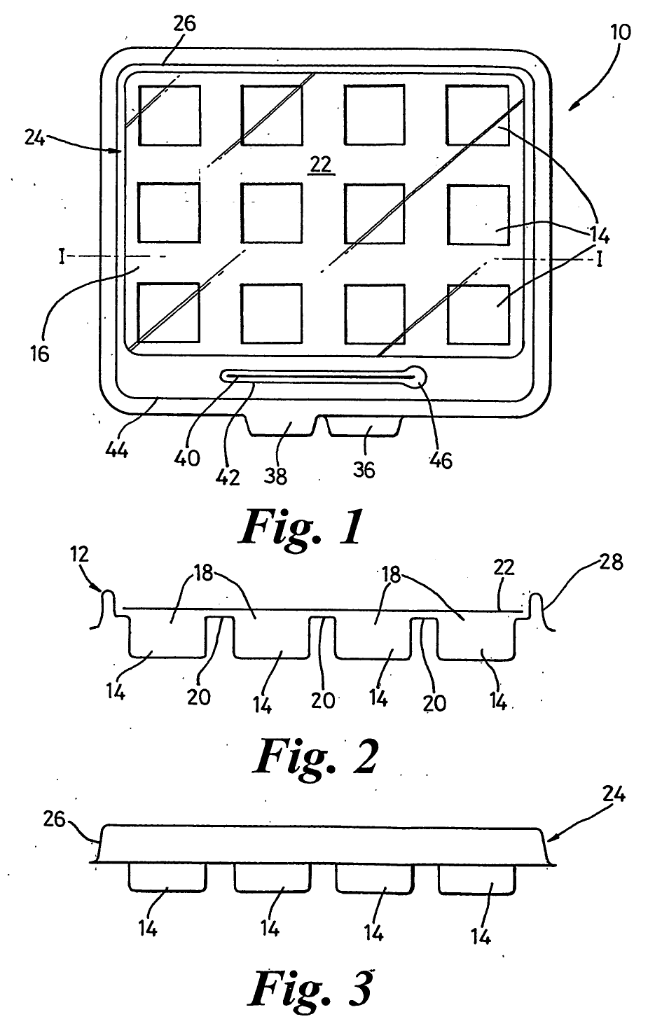

FIG. 1 is a plan view of a pill dispenser according to an embodiment of the invention showing the lid of the dispenser in its first position;

FIG. 2 is a cross-sectional view of the pill dispenser of FIG. 1 along the line I-I;

FIG. 3 is a front elevational view of the pill dispenser of FIG. 1; and

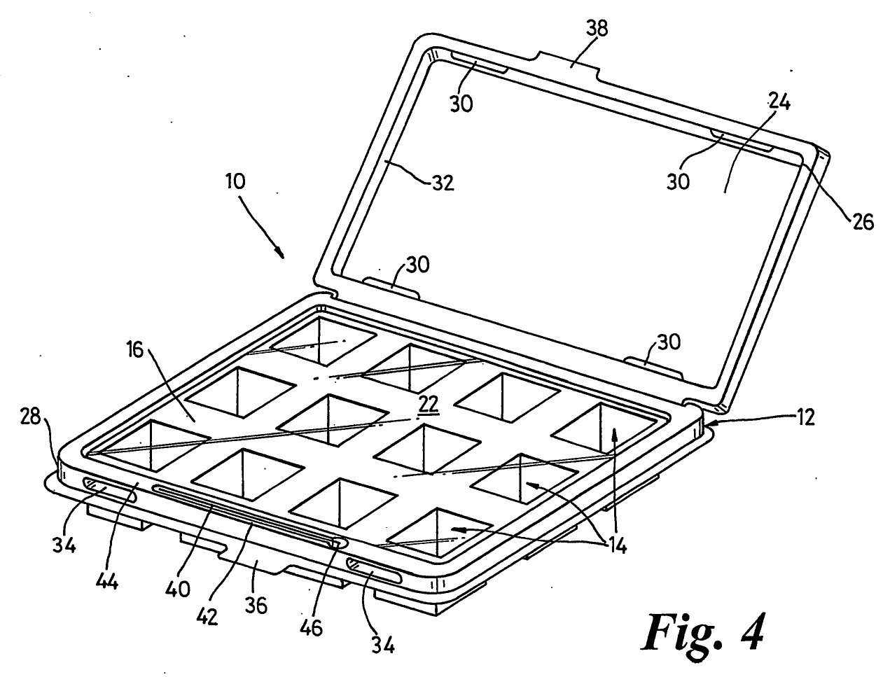

FIG. 4 is a perspective view of the pill dispenser of FIG. 1 showing the lid of the dispenser in its second position.

A pill dispenser 10 according to an embodiment of the invention is shown in FIGS. 1-4.

The pill dispenser 10 includes a body 12 having a plurality of recesses 14 formed in a surface 16 thereof. Each recess 14 includes an open mouth 18 bounded by a surrounding portion 20 of the body surface 16, as shown in FIG. 2.

The open mouth 18 of each recess 14 is closed by an imperforate cover 22 secured to the surrounding portion 20 of the body surface 16 which bounds each recess 14. The imperforate nature of the cover 22 secured over each recess 14 assists in creating a sealed environment in each recess 14 whereby the ingress of moisture, and cross-contamination between the recesses 14, is prevented.

The pill dispenser 10 also includes a lid 24 hingedly connected to the body 12 for movement between first and second positions. In its first position, as shown in FIG. 1, the lid 24 overlies the mouths 18 of all of the recesses 14. In its second position, as shown in FIG. 4, the lid 24 is spaced from the mouths 18 of the recesses 14 to permit access thereto.

In its first position, the lid 24 protects the cover 22 sealingly secured over the open mouth 18 of each recess 14. It also serves to rigidify the body 12 of the pill dispenser 10.

In the embodiment shown in FIGS. 1-4, the lid 24 is formed to define a lip 26 corresponding in shape and size to an outer rim 28 of the body surface 16 such that, in its first position, the lip 26 encircles the rim 28 of the body surface 16.

The lip 26 includes a plurality of projections 30 protruding from an inner surface 32 thereof for snap-fit engagement within corresponding recesses 34 formed in an exterior surface of the rim 28 when the lid 24 is in its first position.

The body 12 and lid 24 are also formed to define tabs 36,38, which extend outwardly in an offset manner relative to one another from opposite edges of the body 12 and the lid 24 respectively to the hinge connection when the lid 24 is in its first position. The provision of such tabs 36,38 provides finger-operable means for levering the lid 24 open.

In other embodiments, the lip 26, rim 28, projections 30 and recesses 32, and/or tabs 36,38 may be omitted.

The body 12 and the lid 24 are preferably formed integrally from a single sheet of plastics material. The sheet of plastics material may be vacuum formed to define the shapes of the body 12 and lid 24, and to define the hinge connection therebetween.

Vacuum forming the body 12 and the lid 24 is advantageous in that it is a relatively cheap method of manufacture. It therefore minimises the production costs of the pill dispenser 10 making the pill dispenser 10 more suitable for one-off applications. It also enables the number of recesses 14 formed in the body surface 16 to be changed relatively easily. This means that a range of pill dispensers 10 having different numbers and arrangements of recesses 14 can be produced, thereby allowing the pharmacist to choose whichever arrangement is most suitable for a particular programme of medicines.

The sheet of plastics material may be formed from polyvinylchloride or amorphous polyethylene terephthalate (APET), for example, and preferably has a thickness in the range of 325-375 microns.

The cover 22 sealingly secured over each recess 14 may be sealingly secured to the surrounding portion 20 of the body surface 16 by an adhesive bond, and preferably by a pressure sensitive adhesive. Preferably, any such adhesive bond forms a permanent bond between the cover 22 and the body surface 16 to prevent tampering once the cover 22 is secured to the body surface 16.

In the embodiment shown in FIGS. 1-4, the cover 22 sealingly secured over each recess 14 is defined by a single sheet of plastics film, which extends over the mouths 18 of all of the recesses 14.

The material from which the cover 22 is formed is preferably chosen such that it requires a significant force to rupture it in order to gain access to the recess 14 below, i.e. to ensure that it cannot be ruptured under finger-pressure. This ensures that the recesses 14 are not easily accessible by children, and thereby renders the pill dispenser 10 child-proof.

The cover is preferably formed from an acetate such as cellulose diacetate film, for example, and may have a thickness in the range of 35-45 microns, the thickness preferably being 40 microns.

In the embodiment shown in FIGS. 1-4, the body surface 16 is recessed relative to the rim 28 of the body 12. This serves to protect the edges of the cover 22 so that the cover 22 cannot be easily peeled away from the body surface 16. It also means that, when the lid 24 is in its first position, the rim 28 of the body 12 spaces the lid 24 from the cover 22 so that the lid does not press on the cover 22. This helps to prevent unintentional rupturing of the cover 22.

The provision of a rim 28 which is raised relative to the body surface 16 also helps to rigidify the body 12.

The pill dispenser 10 shown in FIGS. 1-4 includes an implement in the form of a stylus 40 for rupturing the cover 22. The stylus 40 is housed within an elongate recess 42 formed along a front edge 44 of the body 12. The recess 42 corresponds in shape and size to the stylus 40, along a substantial portion of the length of the stylus 40, and is provided with a well 46 at one end which overlaps with the corresponding end of the stylus 40 and is relatively deeper than the remaining portion of the recess 42.

The body surface 16 may include markings (not shown) to identify individual recesses 14 in terms of time intervals in a dispensing programme for one or more medicines. For example, the markings may identify individual recesses 14 in terms of days and specific time intervals throughout each day.

In use, a pharmacist inserts pills, tablets or capsules, or a combination thereof, into appropriate recesses 14 of the body 12. The cover 22 is then secured to the body surface 16 to close the open mouth 18 of each of the recesses 14.

The pharmacist may also secure a patient card (not shown) to the inner surface of the lid 24 to identify the patient for whom the medicines have been prepared, and to provide information concerning the nature of the medicines contained in the recesses 14. Any such patient card may be in the form of a label having adhesive on its rear surface to enable it to be adhered to the inner surface of the lid 24.

The cover 22 covering the mouth 18 of each recess 14 may include markings (not shown) to identify the recesses 14 and thereby assist a patient. For example, the recesses 14 may be identified in terms of days and specific times throughout each day. Any such markings on the cover 22 are visible to a patient and may be provided in addition, or as an alternative, to markings on the body surface 16. For example, in some embodiments, markings may be provided on the body surface 16 to assist the pharmacist, and further markings may be provided on the cover 22 to assist the patient in the event that the markings on the body surface 16 are obscured by the cover 22.

A patient may only gain access to the medicines contained in each recess 14 by rupturing the cover 22, or portion of cover 22, which extends over the open mouth 18 of that recess 14. The pill dispenser 10 is thereby rendered tamper-evident since it will be clear to the patient if someone has ruptured the cover 22 to tamper with the medicines contained in the recesses 14.

In the embodiment shown in FIGS. 1-4, the stylus 40 provides a suitable means for rupturing the cover 22. The well 46 provided at one end of the recess 42 in which the stylus 40 is housed allows the stylus to be removed relatively easily from the recess 42. This is because on pushing the corresponding end of the stylus 40 downwards, into the well 46, the other end of the stylus 40 is forced upwards out of the recess 42 enabling the user to grip the stylus 40 and pull it out of the recess 42.

In other embodiments, the recess 42 may be provided with a further well at the opposite end of recess 42 to facilitate removal of the stylus 40 from the recess 42 at either end using either well.

While FIG. 4 shows the lid 24 at an angle relative to the body 12 of the dispenser 10 in its second position, it is envisaged that, in other embodiments, the hinge connection between the lid 24 and the body 12 may be formed to enable the lid 24 to be folded back so that it lies under the body 12. In this position the lid 24 may serve to rigidify the body 12 while a patient ruptures the cover 22, or portion of cover 22, over a particular recess 14.

In addition, while the pill dispenser 10 shown in FIGS. 1-4 includes twelve recesses 14 in a 4×3 grid-like configuration, the number of recesses 14 formed in the body surface 16 may vary, as outlined earlier with reference to the manufacture of the body 12. In one particular embodiment, twenty-eight recesses 14 may be formed in the body surface 16 in a 7×4 grid-like configuration. In such an embodiment, the recesses 14 may be labelled, on the body surface 16 and/or the cover 22, to identify the recesses in terms of each day of the week and four separate times during each day such as, for example, breakfast, lunch, dinner and bed.

1. A pill dispenser having a body including a plurality of recesses formed in a surface of the body, each recess having an open mouth bounded by a surrounding portion of said body surface, the open mouth of each recess being closed by an imperforate cover secured to the surrounding portion which bounds the recess, and a lid hingedly connected to the body for movement between a first position whereat the lid overlies the mouth of all of the recesses to prevent access thereto and a second position whereat the lid is spaced from the mouths of the recesses to permit access thereto, characterized in that the body is formed to define a rim around the outer circumference of the body surface such that the mouths of the recesses are recessed relative to the rim.

2. A pill dispenser according to claim 1 wherein the body and lid are integrally formed from a single sheet of plastics material.

3. A pill dispenser according to claim 2 wherein the sheet of plastics material is vacuum formed in order to define the shapes of the body and lid, and to define the hinge connection therebetween.

4. A pill dispenser according to claim 2 wherein the sheet of plastics material is formed from polyvinylchloride or amorphous polyethylene terephthalate.

5. A pill dispenser according to claim 4 wherein the sheet of plastics material has a thickness in the range of 325-375 microns.

6. A pill dispenser according to claim 1 wherein, for each recess, each cover is sealingly secured to the surrounding portion of the body surface by an adhesive bond.

7. A pill dispenser according to claim 6 wherein the adhesive bond is created by a pressure sensitive adhesive.

8. A pill dispenser according to claim 6 wherein the covers are defined by a single sheet of plastics film which extends over the mouths of all of the recesses.

9. A pill dispenser according to claim 8 wherein the plastics film is formed from an acetate.

10. A pill dispenser according to claim 9 wherein the plastics film is formed from cellulose diacetate film.

11. A pill dispenser according to claim 8 wherein the thickness of said plastics film is in the range of 35-45 microns.

12. A pill dispenser according to claim 11 wherein the thickness of said plastics film is 40 microns.

13. A pill dispenser according to claim 1 including an implement for rupturing a cover extending across the mouth of a recess.

14. A pill dispenser according to claim 13 wherein the body includes a receptacle for housing the implement.

15. (canceled)

16. A pill dispenser according to claim 2 wherein, for each recess, each cover is sealingly secured to the surrounding portion of the body surface by an adhesive bond.

17. A pill dispenser according to claim 3 wherein the sheet of plastics material is formed from polyvinylchloride or amorphous polyethylene terephthalate.

18. A pill dispenser according to claim 17 wherein the sheet of plastics material has a thickness in the range of 325-375 microns.

19. A pill dispenser according to claim 7 wherein the covers are defined by a single sheet of plastics film which extends over the mouths of all of the recesses.

20. A pill dispenser according to claim 2 including an implement for rupturing a cover extending across the mouth of a recess.
